(19) United States
(12) Patent Application Publication
(10) Pub. No.: US 2024/0318334 A1
(43) Pub. Date: Sep. 26, 2024

(54) TRIMETALLIC IRON-COBALT-NICKEL AND IRON-CHROMIUM-NICKEL CARBIDE ELECTROCATALYSTS FOR THE OXYGEN EVOLUTION REACTION

(71) Applicant: Florida State University Research Foundation, Inc., Tallahassee, FL (US)

(72) Inventors: Robert A. Lazenby, Tallahassee, FL (US); Geoffrey F. Strouse, Tallahassee, FL (US); Amanda J. Ritz, Tallahassee, FL (US); Isabella A. Bertini, Tallahassee, FL (US)

(21) Appl. No.: 18/613,223

(22) Filed: Mar. 22, 2024

Related U.S. Application Data
(60) Provisional application No. 63/492,089, filed on Mar. 24, 2023.

(51) Int. Cl. C25B 11/075; C01B 32/90; C25B 1/04; H01M 4/90

(52) U.S. Cl. CPC C25B 11/075; C01B 32/90; C25B 1/04; H01M 4/90; C01P 2002/72; C01P 2006/40

(57) ABSTRACT

For renewable energy technology to become ubiquitous, it is imperative to develop efficient oxygen evolution reaction (OER) electrocatalysts, which is challenging due to the kinetically and thermodynamically unfavorable OER mechanism. In accordance with the purpose(s) of the present disclosure, described herein are iron/cobalt/nickel carbide compounds that possess unique electrochemical properties.

### CROSS-REFERENCE TO RELATED APPLICATIONS

This application claims the benefit of and priority to co-pending U.S. Provisional Patent Application No. 63/492,089, filed on Mar. 24, 2023, the contents of which are incorporated by reference herein in their entireties.

### BACKGROUND

Electrochemical water splitting offers a promising route for sourcing green hydrogen, a renewable energy alternative to fossil fuels.¹⁻³ However, the anodic four-electron oxygen evolution reaction (OER) mechanism is kinetically sluggish and thermodynamically unfavorable under alkaline conditions.^{4,5} Despite tremendous efforts in the search for new catalysts to utilize in electrochemical water splitting systems,^{6,7} costly ruthenium and iridium oxide (RuO₂ and IrO₂) electrocatalysts persist as the only viable options for industrial implementation.⁸⁻¹¹ Therefore, the development of alternative highly efficient and low cost electrocatalysts for the OER remains crucial in decreasing the overall energy demand of water splitting.

### SUMMARY

For renewable energy technology to become ubiquitous, it is imperative to develop efficient oxygen evolution reaction (OER) electrocatalysts, which is challenging due to the kinetically and thermodynamically unfavorable OER mechanism. In accordance with the purpose(s) of the present disclosure, described herein are iron/cobalt/nickel carbide compounds that possess unique electrochemical properties.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 shows pXRD patterns of FeₓCo_{y}Ni_{z}C with varying Fe, Co and Ni ratios. Black patterns reflect the Ni₃C rhombohedral (R-3ch) crystal structure. Metal ratios shown were determined by XRF metal composition analysis.

FIGS. 2A-2B show representative linear sweep voltammograms of FeₓCo_{y}Ni_{z}C nanocarbides with varying Fe, Co and Ni ratios in 1.0 M KOH, with a dashed line denoting the benchmarking standard current density of 10 mA cm⁻².

FIG. 3 shows a contour ternary plot of the composition spread of FeₓNi₁₋ₓC_{y}, FeₓCo₁₋ₓC_{y}, CoₓNi₁₋ₓC_{y}, and FeₓCo_{y}Ni_{z}C nanocarbide OER electrocatalyst materials library is shown for overpotentials achieved at a current density of 1 mA cm⁻². Individual points of sample overpotential measurements are determined from LSV in alkaline conditions (n=3) and are plotted for each overpotential measurement extracted from LSV, influencing the color gradient. The color gradient bar ranging from overpotential values of 0.2 to 0.5 V show a contour gradient of dark red (higher electrocatalytic activity, lower overpotentials) to dark blue (lower electrocatalytic activity, higher overpotentials).

FIG. 4 shows pXRD patterns of Fe_{0.23}Ni_{0.70}Cr_{0.07} PBA precursor and Fe_{0.23}Ni_{0.70}Cr_{0.07}C. Blue patterns reflect the K₂FeNi(CN)₆ and black patterns reflect the Ni₃C rhombohedral (R-3ch) crystal structure.

FIGS. 5A-5C show the electrochemical stability of (a) Fe_{0.09}Co_{0.12}Ni_{0.78} nanocarbide for 200 CV cycles compared to (b) Fe_{0.23}Ni_{0.70}Cr_{0.07} nanocarbide for 1000 CV cycles; and (c) Raman spectra collected before (black) and after (magenta) 10 OER CV cycles. All measurements were collected at a mass loading of 0.3 mg cm⁻².

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present compounds, compositions, articles, devices, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions and Abbreviations

In describing and claiming the disclosed subject matter, the following terminology will be used in accordance with the definitions set forth below.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a solvent” includes, but are not limited to, mixtures or combinations of two or more such solvents, and the like.

It should be noted that ratios, concentrations, amounts, rates, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed and “about 5 to about 15” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance and instances where it does not.

### Iron/Cobalt/Nickel and Iron/Chromium/Nickel Carbide Compounds and Applications Thereof

For renewable energy technology to become ubiquitous, it is imperative to develop efficient oxygen evolution reaction (OER) electrocatalysts, which is challenging due to the kinetically and thermodynamically unfavorable OER mechanism. In accordance with the purpose(s) of the present disclosure, described herein are iron/cobalt/nickel and iron/chromium/nickel carbide compounds possessing unique electrochemical properties.

In one aspect, the relative amount of iron to cobalt/chromium and nickel can be used to tune the electrocatalytic activity of the iron/cobalt/nickel carbide compounds described herein. In one aspect, the molar ratio of cobalt or chromium to iron is from about 0.5:1 to about 20:1, or about 0.5:1, 1:1, 1.5:1, 2:1, 2.5:1, 3:1, 4:1, 6:1, 8:1, 10:1, 12:1, 14:1, 16:1, 18:1 or 20:1, where any value can be a lower and upper endpoint of a range (e.g., 1:1 to 2:1).

In another aspect, the molar ratio of nickel to iron is from about 0.5:1 to about 15:1, or about 0.5:1, 1:1, 1.5:1, 2:1, 2.5:1, 3:1, 4:1, 6:1, 8:1, 10:1, 12:1, 14:1, or 15, where any value can be a lower and upper endpoint of a range (e.g., 0.5:1 to 2:1).

In another aspect, the molar ratio of nickel to cobalt or chromium is from about 0.5:1 to about 15:1, or about 0.5:1, 1:1, 1.5:1, 2:1, 2.5:1, 3:1, 4:1, 6:1, 8:1, 10:1, 12:1, 14:1, or 15:1, where any value can be a lower and upper endpoint of a range (e.g., 0.5:1 to 2:1).

In another aspect, the iron/cobalt/nickel carbide compounds described herein have the formula FeₓA_{y}Ni_{z}C, wherein A is cobalt or chromium, x is from about 5 mole % to about 75 mole %, y is from about 1 mole % to about 75 mole %, and z is from about 10 mole % to about 90 mole %, wherein the sum of Fe, Co, and Ni is 100 mole %.

In one aspect, x is about 5 mole %, 10 mole %, 15 mole %, 20 mole %, 25 mole %, 30 mole %, 35 mole %, 40 mole %, 45 mole %, 50 mole %, 55 mole %, 60 mole %, 65 mole %, 70 mole %, or 75 mole %, where any value can be a lower and upper endpoint of a range (e.g., 20 mole % to 50 mole %).

In one aspect, y is about 1 mole %, 5 mole %, 10 mole %, 15 mole %, 20 mole %, 25 mole %, 30 mole %, 35 mole %, 40 mole %, 45 mole %, 50 mole %, 55 mole %, 60 mole %, 65 mole %, 70 mole %, or 75 mole %, where any value can be a lower and upper endpoint of a range (e.g., 1 mole % to 50 mole %).

In one aspect, z is about 10 mole %, 15 mole %, 20 mole %, 25 mole %, 30 mole %, 35 mole %, 40 mole %, 45 mole %, 50 mole %, 55 mole %, 60 mole %, 65 mole %, 70 mole %, 75 mole %, 80 mole %, 85 mole %, or 90 mole %, where any value can be a lower and upper endpoint of a range (e.g., 10 mole % to 50 mole %).

In one aspect, the iron/cobalt/nickel carbide and iron/chromium/nickel carbide compounds described herein are produced by
(a) mixing an iron salt, a cobalt salt or a chromium salt, and a nickel salt in water to produce FeANi Prussian blue analog (PBA); and
(b) heating PBA to produce an iron/cobalt/nickel carbide compound or an iron/chromium/nickel carbide compound.

The Examples provide non-limiting procedures for making the iron/cobalt/nickel carbide compounds described herein. In one aspect, K₃Fe(CN)₆, K₃Co(CN)₆, K₂Ni(CN)₄ are mixed in water, where the relative molar amount of the iron, cobalt, and nickel salts is varied. Additional salts such as, for example, FeCl₂, CoC₂, and/or NiCl₂ can be added to form the FeCo Prussian blue analog (PBA). In one aspect, FeCl₂, CoC₂, and NiCl₂ are added in equimolar amounts.

In another aspect, K₃Fe(CN)₆, K₃Cr(CN)₆, K₂Ni(CN)₄ are mixed in water, where the relative molar amount of the iron, chromium, and nickel salts is varied. Additional salts such as, for example, FeCl₂, CrCl₃, and/or NiCl₂ can be added to form the FeCr Prussian blue analog (PBA). In one aspect, FeCl₂, CrCl₃, and NiCl₂ are added in equimolar amounts.

PBA is formed as crystals that can subsequently be isolated. PBA is next heated to produce the iron/cobalt/nickel carbide compounds. In one aspect, PBA is heated at a temperature of from about 250° C. to about 500° C. In another aspect, PBA is heated at a temperature at about 250° C., 300° C., 350° C., 400° C., 450° C., or 500° C., where any value can be a lower and upper endpoint of a range (e.g., 300° C. to 350° C.).

The iron/cobalt/nickel carbide compounds and iron/chromium/nickel carbide compounds described herein possess several properties that make them suitable for the oxygen evolution reaction (OER). In one aspect, the iron/cobalt/nickel carbide compounds and iron/chromium/nickel carbide compounds have an overpotential of from about 0.20 V to about 0.50 V at 1 mA cm⁻², or about 0.20 V, 0.22 V, 0.24 V, 0.26 V, 0.28 V, 0.30 V, 0.32 V, 0.34 V, 0.36 V, 0.38 V, 0.40 V, 0.42 V, 0.44 V, 0.46 V, 0.48 V, or 0.50 V, where any value can be a lower and upper endpoint of a range (e.g., 0.36 V to 0.44 V). In another aspect, the iron/cobalt/nickel carbide compounds and iron/chromium/nickel carbide compounds have a particle size from about 5 nm to about 100 nm.

In one aspect, the iron/cobalt/nickel carbide compound has an X-ray powder diffraction pattern comprising a peak at from 44.0°±0.2° to 45.0°±0.2° 2θ as measured by X-ray powder diffraction using an x-ray wavelength of 1.54 Å, or from 44.0°, 44.1°, 44.2°, 44.3°, 44.4°, 44.5°, 44.6°, 44.7°, 44.8°, 44.9°, or 45.0°, where any value can be a lower and upper endpoint of a range (e.g., 44.1° to 44.8°).

In another aspect, The iron/cobalt/nickel carbide compound has an X-ray powder diffraction pattern comprising a peak at from 41.0°±0.2° to 42.0°±0.2° 2θ as measured by X-ray powder diffraction using an x-ray wavelength of 1.54 Å, or from 41.0°, 41.1°, 41.2°, 41.3°, 41.4°, 41.5°, 41.6°, 41.7°, 41.8°, 41.9°, or 42.0°, where any value can be a lower and upper endpoint of a range (e.g., 41.1° to 41.8°).

In another aspect, the iron/cobalt/nickel carbide compound has an X-ray powder diffraction pattern comprising a peak at from 40.0°±0.2° to 41.0°±0.2° 2θ as measured by X-ray powder diffraction using an x-ray wavelength of 1.54 Å, or from 40.0°, 40.1°, 40.2°, 40.3°, 40.4°, 40.5°, 40.6°, 40.7°, 40.8°, 40.9°, or 41.0°, where any value can be a lower and upper endpoint of a range (e.g., 40.1° to 40.8°).

In another aspect, the iron/cobalt/nickel carbide compound has an X-ray powder diffraction pattern comprising a peak at from 58.0°±0.2° to 59.0°±0.2° 2θ as measured by X-ray powder diffraction using an x-ray wavelength of 1.54 Å, or from 58.0°, 58.1°, 58.2°, 58.3°, 58.4°, 58.5°, 58.6°, 58.7°, 58.8°, 58.9°, or 59.0°, where any value can be a lower and upper endpoint of a range (e.g., 58.3° to 58.7°).

In another aspect, the iron/cobalt/nickel carbide compound has an X-ray powder diffraction pattern comprising a peak at from 70.0°±0.2° to 71.0°±0.2° 2θ as measured by X-ray powder diffraction using an x-ray wavelength of 1.54 Å, or from 70.0°, 70.1°, 71.2°, 70.3°, 70.4°, 70.5°, 70.6°, 70.7°, 70.8°, 70.9°, or 71.0°, where any value can be a lower and upper endpoint of a range (e.g., 70.1° to 70.8°).

In another aspect, the iron/cobalt/nickel carbide compound has an X-ray powder diffraction pattern comprising a peak at from 77.5°±0.2° to 78.5°±0.2° 2θ as measured by X-ray powder diffraction using an x-ray wavelength of 1.54 Å, or from 77.5°, 77.6°, 77.7°, 77.8°, 77.9°, 78.0°, 78.1°, 78.2°, 78.3°, 78.4°, or 78.5°, where any value can be a lower and upper endpoint of a range (e.g., 78.1° to 78.8°).

In one aspect, the iron/cobalt/nickel carbide compound has an X-ray powder diffraction pattern comprising a peak at from 44.0°±0.2° to 45.0°±0.2° 2θ and a peak at from 41.0°±0.2° to 42.0°±0.2° 2θ as measured by X-ray powder diffraction using an x-ray wavelength of 1.54 Å.

In one aspect, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, and a peak at from 39.0°±0.2° to 40.0°±0.2° 2θ as measured by X-ray powder diffraction using an x-ray wavelength of 1.54 Å.

In one aspect, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, and a peak at from 58.0°±0.2° to 59.0°±0.2° 2θ as measured by X-ray powder diffraction using an x-ray wavelength of 1.54 Å.

In one aspect, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, and a peak at from 70.0°±0.2° to 71.0°±0.2° 2θ as measured by X-ray powder diffraction using an x-ray wavelength of 1.54 Å.

In one aspect, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, a peak at from 70.0°±0.2° to 71.0°±0.2° 2θ, and a peak at from 77.5°±0.2° to 78.5°±0.2° 2θ as measured by X-ray powder diffraction using an x-ray wavelength of 1.54 Å.

In one aspect, the iron/chromium/nickel carbide compound has an X-ray powder diffraction pattern comprising a peak at from 44.0°±0.2° to 45.0°±0.2° 2θ as measured by X-ray powder diffraction using an x-ray wavelength of 1.54 Å, or from 44.0°, 44.1°, 44.2°, 44.3°, 44.4°, 44.5°, 44.6°, 44.7°, 44.8°, 44.9°, or 45.0°, where any value can be a lower and upper endpoint of a range (e.g., 44.1° to 44.8°).

In another aspect, The iron/chromium/nickel carbide compound has an X-ray powder diffraction pattern comprising a peak at from 41.0°±0.2° to 42.0°±0.2° 2θ as measured by X-ray powder diffraction using an x-ray wavelength of 1.54 Å, or from 41.0°, 41.1°, 41.2°, 41.3°, 41.4°, 41.5°, 41.6°, 41.7°, 41.8°, 41.9°, or 42.0°, where any value can be a lower and upper endpoint of a range (e.g., 41.1° to 41.8°).

In another aspect, the iron/chromium/nickel carbide compound has an X-ray powder diffraction pattern comprising a peak at from 39.0°±0.2° to 40.0°±0.2° 2θ as measured by X-ray powder diffraction using an x-ray wavelength of 1.54 Å, or from 39.0°, 39.1°, 39.2°, 39.3°, 39.4°, 39.5°, 39.6°, 39.7°, 39.8°, 39.9°, or 40.0°, where any value can be a lower and upper endpoint of a range (e.g., 39.1° to 39.8°).

In another aspect, the iron/chromium/nickel carbide compound has an X-ray powder diffraction pattern comprising a peak at from 58.0°±0.2° to 59.0°±0.2° 2θ as measured by X-ray powder diffraction using an x-ray wavelength of 1.54 Å, or from 58.0°, 58.1°, 58.2°, 58.3°, 58.4°, 58.5°, 58.6°, 58.7°, 58.8°, 58.9°, or 59.0°, where any value can be a lower and upper endpoint of a range (e.g., 58.3° to 58.7°).

In another aspect, the iron/chromium/nickel carbide compound has an X-ray powder diffraction pattern comprising a peak at from 70.5°±0.2° to 71.5°±0.2° 2θ as measured by X-ray powder diffraction using an x-ray wavelength of 1.54 Å, or from 70.5°, 70.6°, 70.7°, 70.8°, 70.9°, 71.0°, 71.1°, 71.2°, 71.3°, 71.4°, or 71.5°, where any value can be a lower and upper endpoint of a range (e.g., 70.6° to 71.3°).

In another aspect, the iron/chromium/nickel carbide compound has an X-ray powder diffraction pattern comprising a peak at from 77.5°±0.2° to 78.5°±0.2° 2θ as measured by X-ray powder diffraction using an x-ray wavelength of 1.54 Å, or from 77.5°, 77.6°, 77.7°, 77.8°, 77.9°, 78.0°, 78.1°, 78.2°, 78.3°, 78.4°, or 78.5°, where any value can be a lower and upper endpoint of a range (e.g., 78.1° to 78.8°).

In another aspect, the iron/chromium/nickel carbide compound has an X-ray powder diffraction pattern comprising a peak at from 44.0°±0.2° to 45.0°±0.2° 2θ and a peak at from 41.0°±0.2° to 42.0°±0.2° 2θ as measured by X-ray powder diffraction using an x-ray wavelength of 1.54 Å.

In another aspect, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, and a peak at from 39.0°±0.2° to 40.0°±0.2° 2θ as measured by X-ray powder diffraction using an x-ray wavelength of 1.54 Å.

In another aspect, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, and a peak at from 58.0°±0.2° to 59.0°±0.2° 2θ as measured by X-ray powder diffraction using an x-ray wavelength of 1.54 Å.

In another aspect, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, and a peak at from 70.5°±0.2° to 71.5°±0.2° 2θ as measured by X-ray powder diffraction using an x-ray wavelength of 1.54 Å.

In another aspect, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, a peak at from 70.5°±0.2° to 71.5°±0.2° 2θ, and a peak at from 77.5°±0.2° to 78.5°±0.2° 2θ as measured by X-ray powder diffraction using an x-ray wavelength of 1.54 Å.

The iron/cobalt/nickel carbide compounds and iron/chromium/nickel carbide compounds described herein can be applied to one or more electrodes employed in an oxygen evolution system. Examples of these systems include, but are not limited to, water electrolysis systems, solar fuels generators, electrowinning systems, electrolytic hydrogen generators, reversible fuel cells, and reversible air batteries. The iron/cobalt/nickel carbide compounds and iron/chromium/nickel carbide compounds and iron/chromium/nickel carbide compounds can be deposited or applied to the electrode surface using techniques known in the art. In one aspect, a solution of the iron/cobalt/nickel carbide compounds and iron/chromium/nickel carbide compounds can be prepared and the electrode can be inserted into the solution. The Examples provide non-limiting procedures for applying the iron/cobalt/nickel carbide compounds and iron/chromium/nickel carbide compounds to electrodes.

### ASPECTS

Aspect 1. A carbide compound having the formula FeANiC, wherein A is cobalt or chromium.

Aspect 2. The compound of Aspect 1, wherein the molar ratio of cobalt or chromium to iron is from about 0.5:1 to about 20:1, the molar ratio of nickel to iron is from about 0.5:1 to about 15:1, and the molar ratio of nickel to cobalt or chromium is from about 0.05:1 to about 15:1.

Aspect 3. The compound of Aspect 1, wherein the compound is the iron/cobalt/nickel carbide compound, the compound has the formula FeₓA_{y}Ni_{z}C, wherein x is from about 5 mole % to about 80 mole %, y is from about 1 mole % to about 75 mole %, and z is from about 5 mole % to about 90 mole %, wherein the sum of Fe, A, and Ni is 100 mole %.

Aspect 4. The compound of Aspect 1, wherein the compound is produced by the process comprising
(a) mixing an iron salt, a cobalt salt or a chromium salt, and a nickel salt in water to produce FeANi Prussian blue analog (PBA); and
(b) heating PBA to produce an iron/cobalt/nickel carbide compound or an iron/chromium/nickel carbide compound.

Aspect 5. The compound of Aspect 4, wherein the iron salt comprises K₃Fe(CN)₆, the cobalt salt comprises K₃Co(CN)₆, the chromium salt comprises K₃Co(CN)₆, and the nickel salt comprises K₂Ni(CN)₄.

Aspect 6. The compound of Aspect 4, wherein step (a) further comprises adding a second iron salt, a second cobalt salt, a second chromium salt, and a second nickel salt.

Aspect 7. The compound of Aspect 6, wherein the second iron salt comprises FeCl₂, the second cobalt salt comprises CoCl₂, the second cobalt salt comprises CrO₃, and the second nickel salt comprises NiCl₂.

Aspect 8. The compound of any one of Aspects 4-7, wherein PBA is heated at a temperature of from about 250° C. to about 500° C.

Aspect 9. The compound of any one of Aspects 1-8, wherein when A is cobalt, the iron/cobalt/nickel carbide compound has an X-ray powder diffraction pattern comprising a peak at from 44.0°±0.2° to 45.0°±0.2° 2θ as measured by X-ray powder diffraction using an x-ray wavelength of 1.54 Å.

Aspect 10. The compound of any one of Aspects 1-8, wherein when A is cobalt, the iron/cobalt/nickel carbide compound has an X-ray powder diffraction pattern comprising a peak at from 44.0°±0.2° to 45.0°±0.2° 2θ and a peak at from 41.0°±0.2° to 42.0°±0.2° 2θ as measured by X-ray powder diffraction using an x-ray wavelength of 1.54 Å.

Aspect 11. The compound of any one of Aspects 1-8, wherein when A is cobalt, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, and a peak at from 39.0°±0.2° to 40.0°±0.2° 2θ as measured by X-ray powder diffraction using an x-ray wavelength of 1.54 Å.

Aspect 12. The compound of any one of Aspects 1-8, wherein when A is cobalt, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, and a peak at from 58.0°±0.2° to 59.0°±0.2° 2θ as measured by X-ray powder diffraction using an x-ray wavelength of 1.54 Å.

Aspect 13. The compound of any one of Aspects 1-8, wherein when A is cobalt, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, and a peak at from 70.0°±0.2° to 71.0°±0.2° 2θ as measured by X-ray powder diffraction using an x-ray wavelength of 1.54 Å.

Aspect 14. The compound of any one of Aspects 1-8, wherein when A is cobalt, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, a peak at from 70.0°±0.2° to 71.0°±0.2° 2θ, and a peak at from 77.5°±0.2° to 78.5°±0.2° 2θ as measured by X-ray powder diffraction using an x-ray wavelength of 1.54 Å.

Aspect 15. The compound of any one of Aspects 1-8, wherein when A is chromium, the iron/chromium/nickel carbide compound has an X-ray powder diffraction pattern comprising a peak at from 44.0°±0.2° to 45.0°±0.2° 2θ as measured by X-ray powder diffraction using an x-ray wavelength of 1.54 Å.

Aspect 16. The compound of any one of Aspects 1-8, wherein when A is chromium, the iron/chromium/nickel carbide compound has an X-ray powder diffraction pattern comprising a peak at from 44.0°±0.2° to 45.0°±0.2° 2θ and a peak at from 41.0°±0.2° to 42.0°±0.2°±20 as measured by X-ray powder diffraction using an x-ray wavelength of 1.54 Å.

Aspect 17. The compound of any one of Aspects 1-8, wherein when A is chromium, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, and a peak at from 39.0°±0.2° to 40.0°±0.2° 2θ as measured by X-ray powder diffraction using an x-ray wavelength of 1.54 Å.

Aspect 18. The compound of any one of Aspects 1-8, wherein when A is chromium, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, and a peak at from 58.0°±0.2° to 59.0°±0.2° 2θ as measured by X-ray powder diffraction using an x-ray wavelength of 1.54 Å.

Aspect 19. The compound of any one of Aspects 1-8, wherein when A is chromium, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, and a peak at from 70.5°±0.2° to 71.5°±0.2° 2θ as measured by X-ray powder diffraction using an x-ray wavelength of 1.54 Å.

Aspect 20. The compound of any one of Aspects 1-8, wherein when A is chromium, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, a peak at from 39.0°±0.2° to 40.0°±0.2° 2θ, a peak at from 58.0°±0.2° to 59.0°±0.2° 2θ, a peak at from 70.5°±0.2° to 71.5°±0.2° 2θ, and a peak at from 77.5°±0.2° to 78.5°±0.2° 2θ as measured by X-ray powder diffraction using an x-ray wavelength of 1.54 Å.

Aspect 21. The compound of any one of Aspects 1-20, wherein the compound has a particle size from about 5 nm to about 100 nm.

Aspect 22. The compound of any one of Aspects 1-20, wherein the compound has an overpotential of from about 0.20 V to about 0.50 V at 1 mA cm⁻².

Aspect 23. The compound of any one of Aspects 1-22, wherein the compound is an oxygen evolution reaction (OER) electrocatalyst.

Aspect 24. An electrode comprising the compound of any one of Aspects 1-22.

Aspect 25. The electrode of Aspect 25, wherein the compound comprises a film on the surface of the electrode.

Aspect 26. An oxygen evolution system comprising one or more electrodes of Aspect 24 or 25.

Aspect 27. An oxygen evolution reaction (OER) electrocatalyst comprising a compound having the formula FeANiC, wherein A is cobalt or chromium, and the compound achieves a current density of 10 mA cm⁻².

Aspect 28. The system of Aspect 26 or 27, wherein the system comprises a water electrolysis system, a solar fuel generator, an electrowinning system, an electrolytic hydrogen generator, a reversible fuel cell, or a reversible air battery.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### EXPERIMENTAL SECTION

Materials. All commercially available reagents were used without further purification. Precursors for FeCoNi PBAs were K₃Fe(CN)₆, K₃Co(CN)₆, and K₂Ni(CN)₄ (Sigma Aldrich, >99%), KCl (Sigma Aldrich, 98%), FeCl₂·4H₂O, CoCl₂·6H₂O (Thermo Fisher, >99%), and NiCl₂·6H₂O (J.T Baker, >97%). Solvents used for synthesis were ultrapure water (18.2 Ωcm⁻¹ at 25.0° C., Thermo Fisher Barnstead E-Pure Ultrapure filtration system), octadecylamine (Thermo Fisher, 90%), acetone (VWR, ACS Grade) and toluene (VWR, ACS Grade).

Synthesis of FeCoNi Prussian Blue Analogue (PBA) Precursors. In a typical synthesis, two precursor solutions are prepared and combine at room temperature to form the PBA precipitate. Briefly, x mmol K₃Fe(CN)₆, y mmol K₃Co(CN)₆, and z mmol K₂Ni(CN)₄ (where 1 mmol=x+y+z) and 5 mmol of KCl in 100 mL of ultrapure water, comprised solution 1. Equal parts FeCl₂, CoC₂, and NiCl₂ are combine in 200 mL of ultrapure water to form solution 2. Solution 2 was then added dropwise to solution 1 at a rate of 5 mL min⁻¹ and vigorously stirred. The subsequent reaction solutions were left for 18 hrs while stirring to grow the PBAs. The PBAs were collected via centrifugation, washed with 300 mL of ultrapure water and dried on the benchtop at room temperature. The PBA precursors were characterized using scanning electron microscopy (SEM using FEI Nova 400), powder X-ray diffraction, and X-ray fluorescence.

Synthesis of FeCoNi Nanocarbides. 200 mg of solid PBA and 40 mL of octadecylamine (ODA) were heated to 330° C., under inert atmosphere for 1 hr. Thereafter, the reaction was quenched using toluene and the resultant nanocarbide was collected via magnetic separation. The nanoparticles were washed with toluene (3×), acetone (1×), ultrapure water (3×), and again with acetone (1×), then dried in an oven at 100° C. for 15 minutes. The nanoparticles were structurally characterized using pXRD. Elemental composition was confirmed using XRF spectroscopy. Morphology and size analyses were executed using transmission electron microscopy (TEM, FEI CM300 FEG).

Synthesis of FeCoNi Oxides. 200 mg of solid PBA was loaded into a quartz boat and placed into a Lindberg tube furnace. The PBA was subsequently heated to 300° C. with a ramp rate of 60° C. min⁻¹, for 30 minutes open to air. The resultant oxides were structurally characterized with pXRD and XRF.

Synthesis of FeCrNi Nanocarbide. For the synthesis of Fe_{0.2}Ni_{0.7}Cr_{0.1}C, 0.33 mmol K₃Fe(CN)₆, 0.33 mmol K₂Ni(CN)₄ and 0.33 mmol K₃Cr(CN)₆, and (i.e. 1 mmol total) and 5 mmol of KCl in 100 mL of ultrapure water, comprised solution 1. Equal parts FeCl₂, NiCl₂ and CrCl₃ were combined in 200 mL of ultrapure water to form solution 2. The aged PBAs were collected via centrifugation, purified with 300 mL of ultrapure water, and dried on the benchtop at room temperature. Subsequently, 200 mg of solid PBA and 40 mL of octadecylamine (ODA) (Thermo Fisher, 90%) were heated to 330° C. under an inert atmosphere for 1 h and the resulting nanocarbides were collected through magnetic separation. The nanocarbides were purified with toluene (VWR, ACS Grade) (3×), acetone (VWR, ACS Grade) (1×), ultrapure water (18.2 Ωcm⁻¹ at 25.0° C., Thermo Fisher Barnstead E-Pure Ultrapure filtration system) (3×), and again with acetone (1×), then dried in an oven at 100° C. for 15 minutes.

Materials Characterization. PXRD patterns of PBAs, PBA derived carbides and PBA derived oxides were collected at room temperature on a Rigaku Miniflex powder diffractometer (Cu K_{α} source, λ=1.54 Å). The bimetallic ratios in both PBA and nanocarbide were confirmed using XRF on a Panalytical Epsilon X-ray florescence analyzer (Cu K_{α} source). X-ray photoelectron spectroscopy (XPS) was performed on as-synthesized FeNi carbide powders deposited on carbon tape using a PHI 5100 X-ray photoelectron spectrometer (Mg K_{α} source) with a pass energy of 22.36 eV. The XPS spectra were fitted using CasaXPS software. Samples were Ar⁺-sputtered using a sputtering gun at 5 keV and 1 μA for 15 minutes to reveal underlying carbide features. All samples were calibrated to the aliphatic carbon assignment (C1s, 284.8 eV). Size, size dispersity, and morphology of PBA precursors were investigated using ImageJ software (sample size=300 particles) via SEM images (FEI Nova 400). Size, size dispersity, and morphology of the nanocarbides were estimated using ImageJ software (sample size=100 particles) via TEM images, collected on a Tecnai Osiris TEM operating at 200 kV.

Electrochemical Measurements. All electrochemical measurements were performed using a RDE setup equipped with an electrode rotator (WaveVortex 10, Pine Research Instrumentation) set to 1500 rpm, connected to a potentiostat (model CH 660E, CH instruments) within a compartmentalized electrochemical glass cell filled with approximately 250 mL of 1.0 M KOH. A three-electrode setup was used with a GC RDE as the working electrode, a Ag/AgCl reference electrode (1.0 M KCl internal filling solution), and a graphite rod counter electrode.

The electrochemical surface area (ECSA) was determined for each sample using the double layer capacitance, C_{dl}, measured by cyclic voltammetry (CV), so that current densities could be estimated.¹³⁻¹⁵ The charging current, i_{c}, is proportional to the potential scan rate, v, shown in the relationship

$${i}_{c} = v {C}_{dl} \qquad ( 1 )$$

By varying the scan rate (10, 20, 50 and 100 mV s⁻¹), a plot of i_{c} as a function of v will yield a straight line where C_{dl} is the gradient, using CVs recorded in a designated potential window of the nonfaradaic region of the CV, from 0.81 to 1.00 V vs. RHE. ECSA was calculated using the determined value of C_{dl} using

$$ECSA = {C}_{dl} / {C}_{s} \qquad ( 2 )$$

where Cₛ is the specific capacitance of the material. We used a value for Cₛ of 45 μF cm⁻² for the FeₓCo₁₋ₓC_{y} samples, based on reported values in literature for TMs on GC electrodes in the range of 30-70 μF cm⁻².^{16,17}

In 1.0 M KOH (pH=13.8) electrolyte, the potentials against Ag/AgCl can be converted to potentials vs. the reversible hydrogen electrode (RHE) using

$${E}_{vs . RHE} = {E}_{vs . Ag / AgCl} + 0.0 \; 59 pH \qquad ( 3 )$$

which was used to calculate the overpotential, η, using

$$η = {E}_{v s . R H E} - 1.23 V \qquad ( 4 )$$

Additionally, a master reference electrode (not used in experiments) was compared against the Ag/AgCl reference electrode used experimentally and was observed to change no more than a 5 mV difference to ensure a stable, well-defined electrochemical potential.

Tafel slopes were calculated from the linear kinetic region of the Tafel plot, i.e. log (current density) vs. overpotential, at the early onset current in the LSV curves. Electrochemical stability measurements were performed for 200 repetitive CV cycles, with a potential range of 1.0 to 1.8 V vs. RHE, using a scan rate of 1 mV s⁻¹.

Raman spectroscopy measurements. A removable Au disk electrode (5 mm diameter) (Pine Research, Model Number: AFE5T050GC) was utilized for conducting ex-situ Raman spectroscopy measurements. Raman spectroscopy data were generated on a confocal Raman spectrometer (LabRAM HR Evolution, Horiba Scientific) and acquired using a 532 nm laser at 10% laser intensity with a maximum power of 100 mW, a grating of 600 lines (500 nm), and a laser spot size of 25 μm. Each sample was calibrated against a polystyrene reference. Data analysis and peak integrations were performed using programming software LABSpec6.

### Results and Discussion

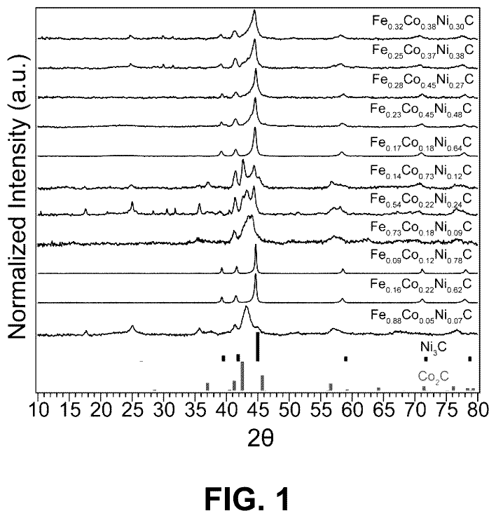

FIG. 1 shows the pXRD patterns of FeₓCo_{y}Ni_{z}C with varying Fe, Co and Ni ratios. Black patterns reflect the Ni₃C rhombohedral (R-3ch) crystal structure.

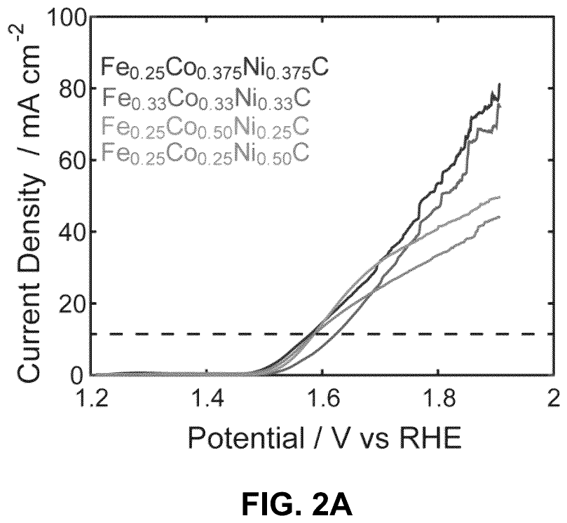

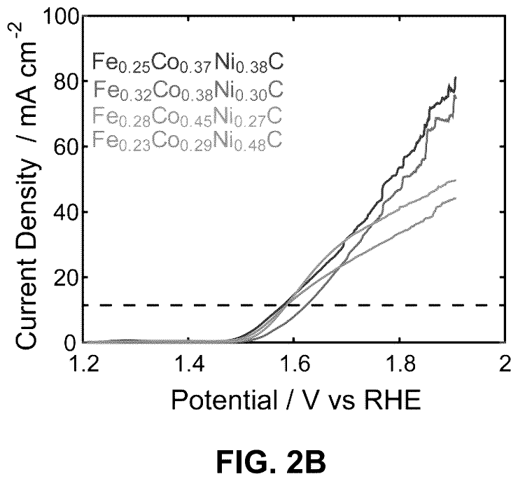

FIG. 2 shows representative linear sweep voltammograms of FeₓCo_{y}Ni_{z}C nanocarbides with varying Fe, Co and Ni ratios in 1.0 M KOH, with a dashed line denoting the benchmarking standard current density of 10 mA cm⁻².

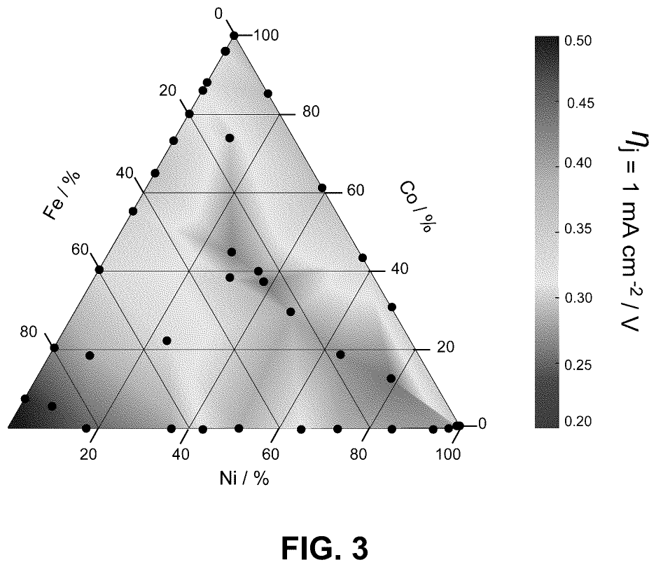

FIG. 3 shows a contour ternary plot of the composition spread of FeₓNi₁₋ₓC_{y}, FeₓCo₁₋ₓC_{y}, CoₓNi₁₋ₓC_{y}, and FeₓCo_{y}Ni_{z}C nanocarbide OER electrocatalyst materials library is shown for overpotentials achieved at a current density of 1 mA cm⁻². Individual points of sample overpotential measurements are determined from LSV in alkaline conditions (n=3) and are plotted for each overpotential measurement extracted from LSV, influencing the color gradient. The color gradient bar ranging from overpotential values of 0.2 to 0.5 V show a contour gradient of dark red (higher electrocatalytic activity, lower overpotentials) to dark blue (lower electrocatalytic activity, higher overpotentials).

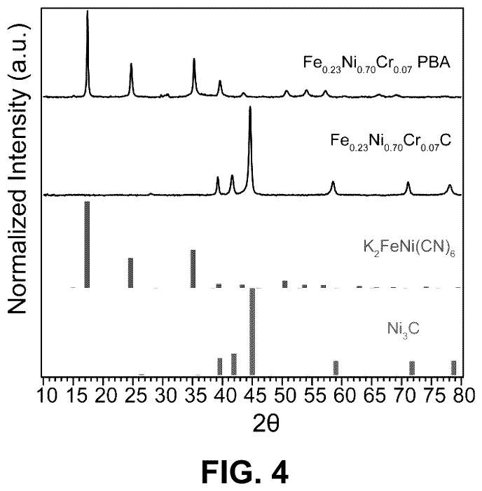

FIG. 4 shows pXRD patterns of Fe_{0.23}Ni_{0.70}Cr_{0.07} PBA precursor and Fe_{0.23}Ni_{0.70}Cr_{0.07}C. Blue patterns reflect the K₂FeNi(CN)₆ and black patterns reflect the Ni₃C rhombohedral (R-3ch) crystal structure.

| Sample | Peak/2θ |
|---|---|
| Ni₃C | 24.5, 39.6, 41.9, 45.0, 58.9, 71.8, 78.7 |
| Co₂C | 37.0, 41.3, 42.6, 45.7, 56.6, 71.4, 76.1 |
| PBA | 17.3, 24.6, 30.3, 35.1 |
| Fe_{0.09}Co_{0.12}Ni_{0.78}C | 39.3, 41.7, 44.7, 58.6, 71.1, 78.1 |
| Fe_{0.14}Co_{0.73}Ni_{0.12}C | 36.0, 41.5, 42.7, 44.5, 56.8, 70.7, 77.0 |
| Fe_{0.16}Co_{0.22}Ni_{0.62}C | 39.3, 41.7, 44.7, 58.6, 71.1, 78.1 |
| Fe_{0.17}Co_{0.18}Ni_{0.64}C | 39.1, 41.3, 44.5, 58.2, 70.7, 77.7 |
| Fe_{0.23}Co_{0.29}Ni_{0.48}C | 39.1, 41.3, 44.5, 58.2, 70.7, 77.7 |
| Fe_{0.25}Co_{0.37}Ni_{0.38}C | 24.7, 39.1, 41.3, 44.5, 58.2, 70.7, 77.7 |
| Fe_{0.28}Co_{0.45}Ni_{0.27}C | 39.1, 41.3, 44.5, 58.2, 70.7, 77.7 |
| Fe_{0.32}Co_{0.38}Ni_{0.30}C | 24.7, 39.1, 41.3, 44.5, 58.2, 70.7, 77.7 |
| Fe_{0.54}Co_{0.22}Ni_{0.24}C | 17.6, 25.0, 30.6, 31.9, 35.8, 36.0, 41.5, 42.6, 43.2, |
| | 44.4, 57.0, 58.0, 70.6, 76.6, 77.6 |
| Fe_{0.73}Co_{0.18}Ni_{0.09}C | 36.0, 41.2, 43.4, 44.0, 57.2, 62.5, 76.6 |
| Fe_{0.88}Co_{0.05}Ni_{0.07}C | 17.7, 25.0, 35.7, 37.6, 41.3, 43.1, 57.2, 67.2, 76.7 |
| Fe_{0.23}Ni_{0.70}Cr_{0.07}C | 39.2, 41.7, 44.7, 58.5, 71.1, 78.1 |

Table 1 shows peak pXRD assignment of trimetallic FeₓA_{y}Ni_{z}C compounds compared to Ni₃C CO₂C, and PBA references.

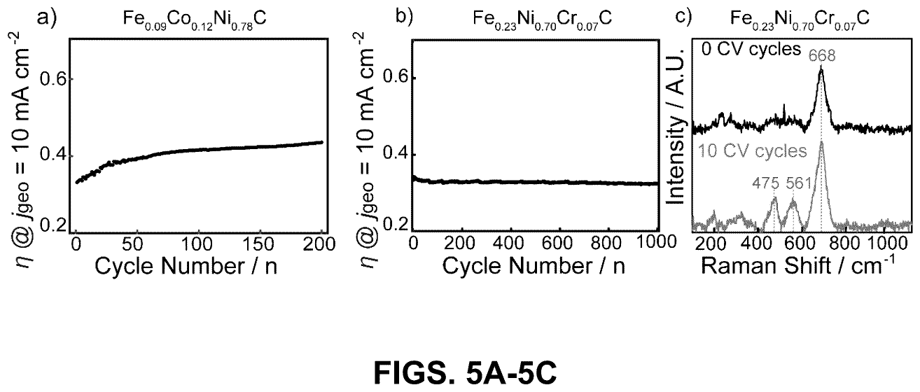

FIGS. 5A-5C show the electrochemical stability of (a) Fe_{0.09}Co_{0.12}Ni_{0.78} nanocarbide for 200 CV cycles compared to (b) Fe_{0.23}Ni_{0.70}Cr_{0.07} nanocarbide for 1000 CV cycles; and (c) Raman spectra collected before (black) and after (magenta) 10 OER CV cycles. All measurements were collected at a mass loading of 0.3 mg cm⁻².

The Fe_{0.09}Co_{0.12}Ni_{0.78} nanocarbide in FIG. 5A shows that a significant increase in overpotential (i.e degradation of the catalyst) occurred in the first 50 OER CV cycles. However, the long-term electrochemical stability assessment of Fe_{0.23}Ni_{0.70}Cr_{0.07}C revealed a highly stable electrocatalyst for 1000 OER CV cycles in 1.0 M KOH with minimal change in overpotential, shown in FIG. 5B. The ex-situ Raman spectra before and after 10 OER CV cycles are shown for the Fe_{0.23}Ni_{0.70}Cr_{0.07}C sample in FIG. 5C, with distinct peaks at 475, 561, and 668 cm⁻¹. The peak occurring at 561 cm⁻¹ can be attributed to Cr—O bending modes, indicating that the chromium oxide layer formed.¹ The peak at 668 cm⁻¹ can be ascribed to the A1_{g} phonon mode of spinel Fe₃O₄,^{2,3} and 475 cm⁻¹ likely is attributed to vibrations for Ni—O.⁴⁸ These findings suggest that, despite the formation of surface metal oxides such as Fe₃O₄ and NiO, the catalyst's degradation was effectively mitigated in the presence of the chromium oxide layer. This points to the chromium oxide layer's ability to create a robust oxide surface layer, acting as a barrier that prevents O₂ from reacting with Fe and thereby averting further catalyst degradation.

Table 2 shows the overpotential values achieved at a current density of 1 mA cm⁻² for FeₓCo_{y}Ni_{z}C nanocarbide OER electrocatalysts with varying Fe, Co and Ni ratios.

TABLE 2
Overpotential values achieved at a current density of 10 mA
cm⁻² for FeₓCo_{y}Ni_{z}C nanocarbide OER electrocatalysts with
varying Fe, Co and Ni ratios at a mass loading of 0.1 mg cm⁻².

| Fe/% | Co/% | Ni/% | η @ j = 10 mA cm⁻²/V |
|---|---|---|---|
| 9 | 12 | 78 | 0.328 ± 0.007 |
| 14 | 73 | 12 | 0.446 ± 0.030 |
| 16 | 22 | 62 | 0.378 ± 0.010 |
| 17 | 18 | 64 | 0.538 ± 0.026 |
| 23 | 29 | 48 | 0.349 ± 0.004 |
| 25 | 37 | 38 | 0.390 ± 0.002 |
| 28 | 45 | 27 | 0.347 ± 0.007 |
| 32 | 38 | 30 | 0.388 ± 0.003 |
| 54 | 22 | 24 | 0.421 ± 0.019 |
| 73 | 18 | 9 | 0.538 ± 0.026 |
| 88 | 5 | 7 | —* |

*does not achieve a current density of 10 mA cm⁻², η = 0.473 V at 1 mA cm⁻².

It should be emphasized that the above-described embodiments of the present disclosure are merely possible examples of implementations and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

### REFERENCES

ADDIN EN.REFLIST (1) Li, X.; Zhao, L.; Yu, J.; Liu, X.; Zhang, X.; Liu, H.; Zhou, W. Water Splitting: From Electrode to Green Energy System. Nano-Micro Lett. 2020, 12 (1), 131.
(2) Bard, A. J.; Fox, M. A. Artificial Photosynthesis: Solar Splitting of Water to Hydrogen and Oxygen. Acc. Chem. Res. 1995, 28 (3), 141-145.
(3) Stöckl, F.; Schill, W. P.; Zerrahn, A. Optimal Supply Chains and Power Sector Benefits of Green Hydrogen. Sci. Rep. 2021, 11 (1), 14191.
(4) Liang, Q.; Brocks, G.; Bieberle-Hütter, A. Oxygen Evolution Reaction (OER) Mechanism under Alkaline and Acidic Conditions. J. Phys. Energy 2021, 3 (2), 026001.
(5) Xie, X.; Du, L.; Yan, L.; Park, S.; Qiu, Y.; Sokolowski, J.; Wang, W.; Shao, Y. Oxygen Evolution Reaction in Alkaline Environment: Material Challenges and Solutions. Adv. Funct. Mater. 2022, 32 (21), 2110036.
(6) Roger, I.; Shipman, M. A.; Symes, M. D. Earth-Abundant Catalysts for Electrochemical and Photoelectrochemical Water Splitting. Nat. Rev. Chem. 2017, 1 (003), 0003.
(7) Maeda, K.; Domen, K. Photocatalytic Water Splitting: Recent Progress and Future Challenges. J. Phys. Chem. Lett. 2010, 1 (18), 2655-2661.
(8) Deng, H.; Zhang, C.; Xie, Y.; Tumlin, T.; Giri, L.; Karna, S. P.; Lin, J. Evolution Reaction Catalysts †. J. Mater. Chem. A 2016, 4 (6303), 6824-6830.
(9) Audichon, T.; Napporn, T. W.; Canaff, C.; Morais, C.; Comminges, C.; Kokoh, K. B. IrO2 Coated on RuO2 as Efficient and Stable Electroactive Nanocatalysts for Electrochemical Water Splitting. J. Phys. Chem. C 2016, 120 (5), 2562-2573.
(10) Cao, L.; Luo, Q.; Chen, J.; Wang, L.; Lin, Y.; Wang, H.; Liu, X.; Shen, X.; Zhang, W.; Liu, W.; Qi, Z.; Jiang, Z.; Yang, J.; Yao, T. Dynamic Oxygen Adsorption on Single-Atomic Ruthenium Catalyst with High Performance for Acidic Oxygen Evolution Reaction. Nat. Commun. 2019, 10 (1), 4849.
(11) Lee, Y.; Suntivich, J.; May, K. J.; Perry, E. E.; Shao-Horn, Y. Synthesis and Activities of Rutile IrO2 and RuO2 Nanoparticles for Oxygen Evolution in Acid and Alkaline Solutions. J. Phys. Chem. Lett. 2012, 3 (3), 399-404.
(12) Hardy, D. A.; Nguyen, E. T.; Parrish, S. E.; Schriber, E. A.; Schlicker, L.; Gili, A.; Kamutzki, F.; Hohman, J. N.; Strouse, G. F. Prussian Blue Iron-Cobalt Mesocrystals as a Template for the Growth of Fe/Co Carbide (Cementite) and Fe/Co Nanocrystals. Chem. Mater. 2019, 31 (19), 8163-8173. https://doi.org/10.1021/acs.chemmater.9b02957.
(13) Hominins, T. A.; Evolution, H.; Publishing, B. Some Thoughts about Reporting the Electrocatalytic Performance of Nanomaterials. Appl. Mater. Today 2004, 2(1979), 71-83.
(14) McCrory, C. C. L.; Jung, S.; Ferrer, I. M.; Chatman, S. M.; Peters, J. C.; Jaramillo, T. F. Benchmarking Hydrogen Evolving Reaction and Oxygen Evolving Reaction Electrocatalysts for Solar Water Splitting Devices. J. Am. Chem. Soc. 2015, 137(13), 4347-4357. https://doi.org/10.1021/ja510442p.
(15) Anantharaj, S.; Ede, S. R.; Karthick, K.; Sam Sankar, S.; Sangeetha, K.; Karthik, P. E.; Kundu, S. Precision and Correctness in the Evaluation of Electrocatalytic Water Splitting: Revisiting Activity Parameters with a Critical Assessment. Energy Environ. Sci. 2018, 11 (4), 744-771. https://doi.org/10.1039/c7ee03457a.
(16) Pell, W. G.; Zolfaghari, A.; Conway, B. E. Capacitance of the Double-Layer at Polycrystalline Pt Electrodes Bearing a Surface-Oxide Film. J. Electroanal. Chem. 2002, 532 (1-2), 13-23. https://doi.org/10.1016/S0022-0728(02)00676-9.
(17) Lukaszewski, M.; Soszko, M.; Czerwihski, A. Electrochemical Methods of Real Surface Area Determination of Noble Metal Electrodes—an Overview. Int. J. Electrochem. Sci. 2016, 11 (6), 4442-4469. https://doi.org/10.20964/2016.06.71.

1. A carbide compound having the formula FeANiC, wherein A is cobalt or chromium.

2. The compound of claim 1, wherein the molar ratio of cobalt or chromium to iron is from about 0.5:1 to about 20:1, the molar ratio of nickel to iron is from about 0.5:1 to about 15:1, and the molar ratio of nickel to cobalt or chromium is from about 0.05:1 to about 15:1.

3. The compound of claim 1, wherein the compound is the iron/cobalt/nickel carbide compound, the compound has the formula FeₓA_{y}Ni_{z}C, wherein x is from about 5 mole % to about 80 mole %, y is from about 1 mole % to about 75 mole %, and z is from about 5 mole % to about 90 mole %, wherein the sum of Fe, A, and Ni is 100 mole %.

4. The compound of claim 1, wherein the compound is produced by the process comprising
(a) mixing an iron salt, a cobalt salt or a chromium salt, and a nickel salt in water to produce FeANi Prussian blue analog (PBA); and
(b) heating PBA to produce an iron/cobalt/nickel carbide compound or an iron/chromium/nickel carbide compound.

5. The compound of claim 4, wherein the iron salt comprises K₃Fe(CN)₆, the cobalt salt comprises K₃Co(CN)₆, the chromium salt comprises K₃Co(CN)₆, and the nickel salt comprises K₂Ni(CN)₄.

6. The compound of claim 4, wherein step (a) further comprises adding a second iron salt, a second cobalt salt, a second chromium salt, and a second nickel salt.

7. The compound of claim 6, wherein the second iron salt comprises FeCl₂, the second cobalt salt comprises CoCl₂, the second cobalt salt comprises CrCl₃, and the second nickel salt comprises NiCl₂.

8. The compound of claim 1, wherein when A is cobalt, the iron/cobalt/nickel carbide compound has an X-ray powder diffraction pattern comprising a peak at from 44.0°±0.2° to 45.0°±0.2° 2θ as measured by X-ray powder diffraction using an x-ray wavelength of 1.54 Å.

9. The compound of claim 1, wherein when A is cobalt, the iron/cobalt/nickel carbide compound has an X-ray powder diffraction pattern comprising a peak at from 44.0°±0.2° to 45.0°±0.2° 2θ and a peak at from 41.0°±0.2° to 42.0°±0.2° 2θ as measured by X-ray powder diffraction using an x-ray wavelength of 1.54 Å.

10. The compound of claim 1, wherein when A is cobalt, the iron/cobalt/nickel carbide compound has an X-ray powder diffraction pattern comprising a peak at from 44.0°±0.2° to 45.0°±0.2° 2θ, a peak at from 41.0°±0.2° to 42.0°±0.2° 2θ, and a peak at from 39.0°±0.2° to 40.0°±0.2° 2θ as measured by X-ray powder diffraction using an x-ray wavelength of 1.54 Å.

11. The compound of claim 1, wherein when A is chromium, the iron/chromium/nickel carbide compound has an X-ray powder diffraction pattern comprising a peak at from 44.0°±0.2° to 45.0°±0.2° 2θ as measured by X-ray powder diffraction using an x-ray wavelength of 1.54 Å.

12. The compound of claim 1, wherein when A is chromium, the iron/chromium/nickel carbide compound has an X-ray powder diffraction pattern comprising a peak at from 44.0°±0.2° to 45.0°±0.2° 2θ and a peak at from 41.0°±0.2° to 42.0°±0.2° 2θ as measured by X-ray powder diffraction using an x-ray wavelength of 1.54 Å.

13. The compound of claim 1, wherein when A is chromium, the iron/chromium/nickel carbide compound has an X-ray powder diffraction pattern comprising a peak at from 44.0°±0.2° to 45.0°±0.2° 2θ, a peak at from 41.0°±0.2° to 42.0°±0.2° 2θ, and a peak at from 39.0°±0.2° to 40.0°±0.2° 2θ as measured by X-ray powder diffraction using an x-ray wavelength of 1.54 Å.

14. The compound of claim 1, wherein the compound has an overpotential of about 0.2 V to about 0.5 V at 1.0 mA cm⁻².

15. An electrode comprising the compound of claim 1.

16. The electrode of claim 15, wherein the compound comprises a film on the surface of the electrode.

17. An oxygen evolution system comprising one or more electrodes of claim 15.

18. The system of claim 17, wherein the system comprises a water electrolysis system, a solar fuel generator, an electrowinning system, an electrolytic hydrogen generator, a reversible fuel cell, or a reversible air battery.

19. An oxygen evolution reaction (OER) electrocatalyst comprising a compound having the formula FeANiC, wherein A is cobalt or chromium, and the compound achieve a current density of 10 mA cm⁻².
